(19) United States
(12) Patent Application Publication
(10) Pub. No.: US 2013/0147425 A1
(43) Pub. Date: Jun. 13, 2013

(54) WIRELESS CHARGING SYSTEM AND PORTABLE ELECTRONIC DEVICE

(71) Applicant: CHIH-WEI CHANG, Shindian (TW)

(72) Inventor: CHIH-WEI CHANG, Shindian (TW)

(73) Assignee: FIH (HONG KONG) LIMITED, Kowloon (HK)

(21) Appl. No.: 13/562,300

(22) Filed: Jul. 30, 2012

(30) Foreign Application Priority Data
Dec. 9, 2011 (CN) 201110408574.9

(51) Int. Cl. H02J 17/00; H02J 7/14

(52) U.S. Cl. 320/108

(57) ABSTRACT

A wireless charging system includes a stationary portion and a mobile portion. The stationary portion generates a charging magnetic field due to electromagnetic induction in response to receiving a voltage of an external power supply. The mobile portion includes a first magnet, a generator element, and a rechargeable battery, and the generator element includes a second magnet, a shaft, and an induction winding. Both the first magnet and the induction winding fixed on the shaft, and the induction winding is received in the second magnet. The charging magnetic field generates a magnetic force applied to the first magnet and drives the first magnet, the shaft, and the induction winding to rotate. Thus, the induction winding cuts magnetic force lines of the second magnet and generates induction current to charge the rechargeable battery.

### BACKGROUND

1. Technical Field

The present disclosure relates to charging systems for portable electronic devices, and particularly to a wireless charging system and a portable electronic device employing the wireless charging system.

2. Description of Related Art

Rechargeable batteries are widely used in portable electronic devices, such as mobile phones, personal digital assistants (PDA), and laptop computers, for example.

When recharging the rechargeable batteries, the rechargeable batteries generally need to be electrically connected to external power supplies (e.g., wall sockets) using power cords. Thus, users of the portable electronic devices may be burdened to carry the power cords. If a user of a portable electronic device does not carry a power cord adapted to a rechargeable battery of the portable electronic device, he/she may be unable to recharge the rechargeable battery when power of the rechargeable battery is exhausted.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

FIG. 1 is a block diagram of a wireless charging system, according to an exemplary embodiment.

FIG. 2 is a schematic view of a mobile portion of the wireless charging system, according to an exemplary embodiment.

FIG. 3 is a cutaway view along the line shown in FIG. 2.

FIG. 4 is a schematic view of a working process of the mobile portion shown in FIG. 2.

### DETAILED DESCRIPTION

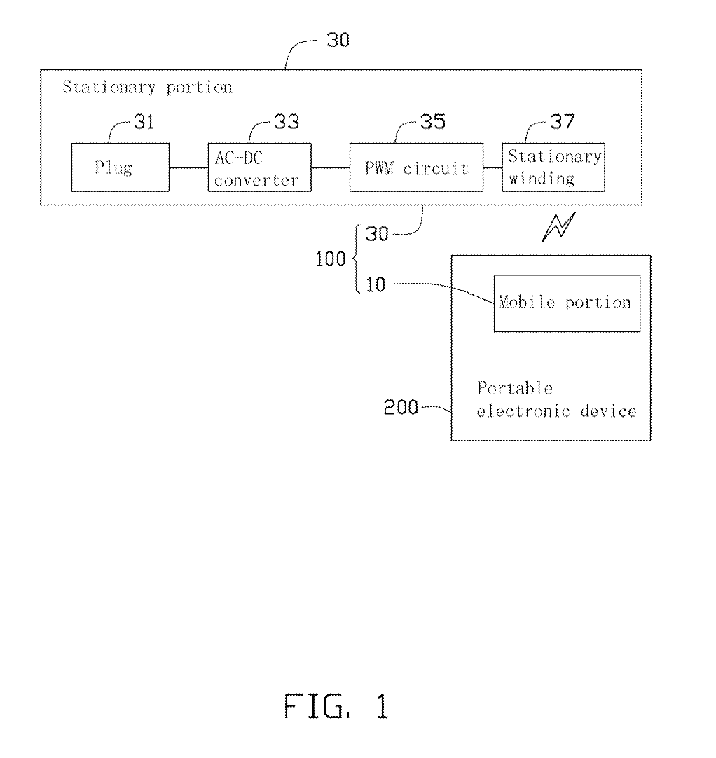

FIG. 1 shows a wireless charging system 100, in accordance with an exemplary embodiment. The wireless charging system 100 can be used to wirelessly recharge a portable electronic device 200. The portable electronic device 200 can be a mobile phone, a personal digital assistant (PDA), or a laptop computer, for example. The wireless charging system 100 includes a mobile portion 10 and a stationary portion 30. The mobile portion 10 is installed in the portable electronic device 200. The stationary portion 30 includes a plug 31, an alternating current-direct current (AC-DC) converter 33, a pulse width modulation (PWM) circuit 35, and a stationary winding 37. The plug 31, the AC-DC converter 33, the PWM circuit 35, and the stationary winding 37 are electrically connected in series.

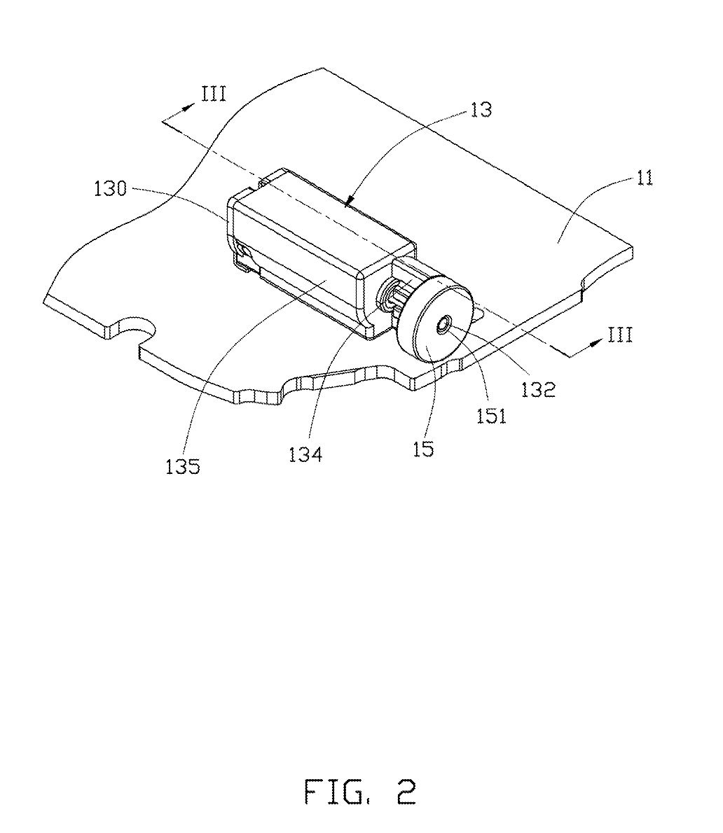

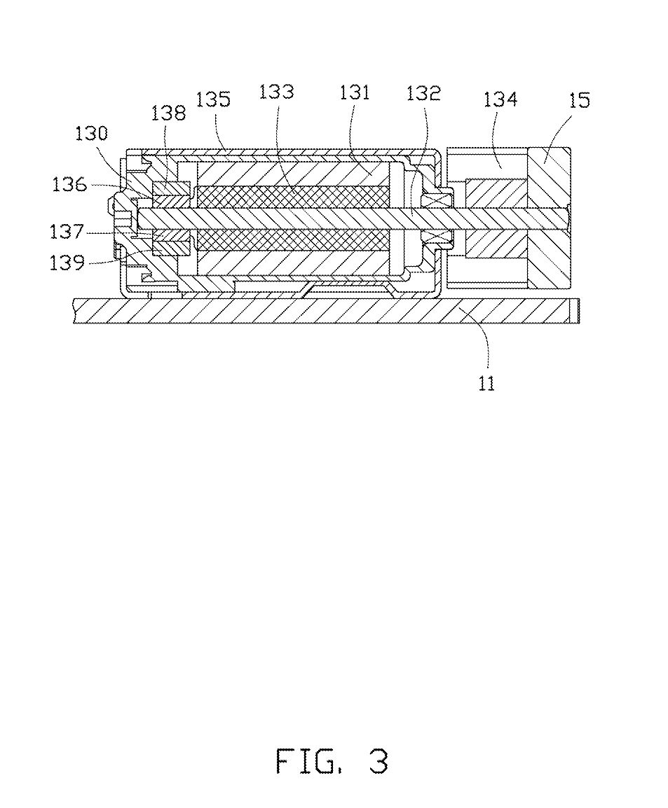

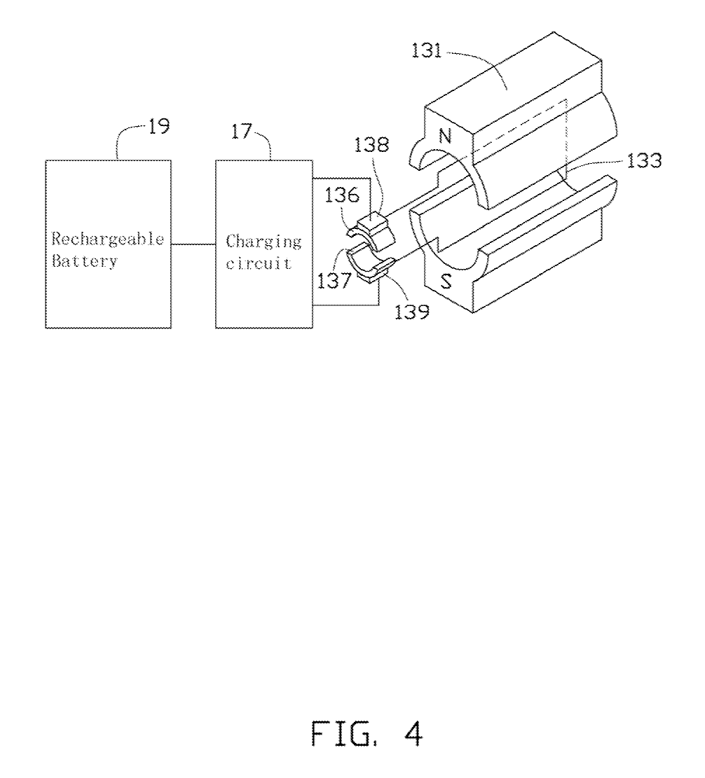

Also referring to FIG. 2, FIG. 3, and FIG. 4, the mobile portion 10 includes a circuit board 11, a generator element 13, a first magnet 15, a charging circuit 17, and a rechargeable battery 19. The circuit board 11 can be integrated with a typical circuit board of the portable electronic device 200. The generator element 13 can be a motor electrically connected to the circuit board 11. The circuit board 11 can control the generator element 13 to generate vibrations according to typical methods. In this embodiment, the generator element 13 can further sense magnetic fields generated by the stationary portion 30 and generate electric power in response to sensing the magnetic fields. The electric power generated by the generator element 13 can be used to wirelessly charge the rechargeable battery 19.

The generator element 13 includes a securing case 130, a second magnet 131, a shaft 132, an induction winding 133, an eccentric wheel 134, an electromagnetic shielding cover 135, a first commutator 136, a second commutator 137, a first brush 138, and a second brush 139. The second magnet 131 is a substantially hollow cylinder. The shaft 132 is coaxially received in the second magnet 131, and is rotatable relative to the second magnet 131. Both two ends of the shaft 132 are exposed out of the second magnet 131. The induction winding 133 is received in the second magnet 131, and is coiled and fixed on the shaft 132. Both the first and second commutators 136, 137 are substantially semi-cylindrical cases, and the first and second commutators 136, 137 are respectively fixed on two opposite sides of one end of the shaft 132 exposed out of the second magnet 131. Two ends of the induction winding 133 are respectively electrically connected to the first and second commutators 136, 137. The first magnet 15 is substantially disk-shaped and coaxially fixed on the other end of the shaft 132 exposed out of the second magnet 131. The eccentric wheel 134 is fixed on a side of the shaft 132 and positioned adjacent to the first magnet 15.

The second magnet 131, the induction winding 133, the first and second commutators 136, 137, and the first and second brushes 138, 139 are all received in the securing case 130. The second magnet 131 and the first and second brushes 138, 139 are all fixed to an inner surface of the securing case 130. The first and second brushes 138, 139 are respectively positioned adjacent to outside surfaces of the first and second commutators 136 and 137. When the shaft 32 is rotated, each of the first and second commutators 136, 137 is driven to rotate by the shaft 32, and alternately contacts and electrically connects with each of the first and second brushes 138, 139. The securing case 130 is received in the electromagnetic shielding cover 135, and both the securing case 130 and the electromagnetic shielding cover 135 are fixed on the circuit board 11. Both the first magnet 15 and the eccentric wheel 134 expose out of the electromagnetic shielding cover 135.

The charging circuit 17 can include typical voltage regulating circuits and current regulating circuits of portable electronic devices. The charging circuit 17 is integrated within the circuit board 11, and is electrically connected to the first and second brushes 138 and 139. The rechargeable battery 19 is electrically connected to the charging circuit 17.

In use, the plug 31 is electrically connected to an external power supply, such as a wall socket, and an AC voltage provided by the external power supply is input to the stationary device 30. The AC-DC converter 33 converts the AC voltage into a DC voltage, and transmits the DC voltage to the PWM circuit 35. The PWM circuit 35 transmits the DC voltage to the stationary winding 37 during predetermined times, and generates pulse voltages having a predetermined period and pulse width, and inputs the pulse voltages to the stationary winding 37. Upon receiving the pulse voltages, the stationary winding 37 generates charging a magnetic field due to electromagnetic induction. The PWM circuit 35 can adjust intensity of the charging magnetic field by adjusting the periods and pulse widths of the pulse voltages input to the stationary winding 37.

If the portable electronic device 200 with the mobile portion 10 is in a predetermined charging range around the stationary portion 30, that is, does not exceed a predetermined distance away from to the stationary portion 30, the intensity of the charging magnetic field is high enough to be sensed by the first magnet 15. Thus, the charging magnetic field generates a magnetic force applied to the first magnet 15, and the first magnet 15 is driven to rotate by the first magnet 15.

The rotation of the first magnet 15 further drives the shaft 132 and the induction winding 133 to rotate relative to the second magnet 131. Also referring to FIG. 4, according to inherent characteristics of magnets, a north magnetic pole N and a south magnetic pole S of the second magnet 131 can be regarded as respectively existing in two opposite semi-cylindrical parts of the second magnet 131. Therefore, magnetic force lines (not shown) connecting the two magnetic poles of the second magnet 131 exist in the center hole of the second magnet 131. When the induction winding 133 received in the second magnet 131 is rotated relative to the second magnet 131, the magnetic force lines are cut by the induction winding 133. Thus, induction current is generated in the induction winding 133 due to electromagnetic induction. The induction current is input to the charging circuit 17 via the first and second commutators 136, 137 and the first and second brushes 138, 139. The charging circuit 17 regulates intensity of the induction current to predetermined values, and transmits the regulated current to the rechargeable battery 19 to charge the rechargeable battery 19 with electric power provided by the induction current. In this way, the rechargeable battery 19 is wirelessly charged.

Furthermore, the first and second brushes 138, 139 can also be electrically connected to the circuit board 11, so that the circuit board 11 can provide a driving voltage (e.g., a voltage of the rechargeable battery 19) to the induction winding 133 via the first and second brushes 138, 139 and the first and second commutators 136, 137, and thereby electrify the induction winding 133. Since the induction winding 133 is positioned in a magnetic field of the second magnet 131, the induction winding 133 is rotated due to electromagnetic induction. The rotation of the induction winding 133 further drives the shaft 132 and the eccentric wheel 134 to rotate, and thus the portable electronic device 200 vibrates due to the rotation of the eccentric wheel 134. In this way, the generator element 13 can also be used as a typical vibration indication device (e.g., a device configured to indicate incoming calls and short messages using vibration) of the portable electronic device 200.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A wireless charging system, comprising:
a stationary portion including a stationary winding and electrically connected to an external power supply, wherein in response to receiving a voltage of the external power supply, the stationary portion generates pulse voltages that are input to the stationary winding, and the stationary winding generates a charging magnetic field due to electromagnetic induction caused by the pulse voltages; and
a mobile portion, the mobile portion including a first magnet, a generator element, and a rechargeable battery; the generator element including a second magnet, a shaft, and an induction winding, both the first magnet and the induction winding are fixed on the shaft, the induction winding received in the second magnet and electrically connected to the rechargeable battery, and the first magnet, the shaft, and the induction winding being rotatable relative to the second magnet;
wherein the charging magnetic field generates a magnetic force applied to the first magnet, the first magnet, the shaft, and the induction winding are driven to rotate relative to the second magnet causing induction current to be generated in the induction winding due to electromagnetic induction between the second magnet and the induction winding and transmitted to the rechargeable battery to charge the rechargeable battery.

2. The wireless charging system of claim 1, wherein the stationary portion further includes a plug, an alternating current-direct current (AC-DC) converter, and a pulse width modulation (PWM) circuit; the plug, the AC-DC converter, the PWM circuit, and the stationary winding are electrically connected in series.

3. The wireless charging system of claim 2, wherein the plug is configured to be electrically connected to the external power supply, the AC-DC converter is configured to convert the voltage of the external power supply to a direct current (DC) voltage, and the PWM circuit is configured to transmit the DC voltage to the stationary winding during predetermined times and thereby generate the pulse voltages.

4. The wireless charging system of claim 1, wherein the generator element further includes two commutators and two brushes; the two commutators are fixed on the shaft and respectively electrically connected to two ends of the induction winding, and the two brushes are fixed relative to the second magnet and respectively positioned adjacent to outside surfaces of the two commutators; and when the shaft rotates relative to the second magnet, each of the two commutators is driven to alternately contact and electrically connect with each of the two brushes.

5. The wireless charging system of claim 4, wherein the second magnet is a substantially hollow cylinder, the shaft is coaxially received in the second magnet, and the induction winding is coiled on the shaft.

6. The wireless charging system of claim 5, wherein both two ends of the shaft expose out of the second magnet, the two commutators are respectively fixed on two opposite sides of one end of the shaft exposed out of the second magnet, and the first magnet is substantially disk-shaped and coaxially fixed on the other end of the shaft exposed out of the second magnet.

7. The wireless charging system of claim 6, wherein the generator element further includes a securing case; the second magnet, the induction winding, the two commutators, and the two brushes are all received in the securing case, and the second magnet and the two brushes are all fixed to an inner surface of the securing case.

8. The wireless charging system of claim 7, wherein the generator element further includes an electromagnetic shielding cover, the securing case is received in the electromagnetic shielding cover, and the first magnet exposes out of the electromagnetic shielding cover.

9. The wireless charging system of claim 8, wherein the generator element further includes an eccentric wheel; the eccentric wheel is fixed on a side of the shaft and positioned adjacent to the first magnet, and the eccentric wheel exposes out of the shielding cover.

10. The wireless charging system of claim 9, wherein the mobile portion further includes a circuit board and a charging circuit integrated within the circuit board; both the securing case and the electromagnetic shielding cover are fixed on the circuit board, and both the two brushes are electrically connected to the rechargeable battery via the charging circuit.

11. A portable electronic device, comprising:
a rechargeable battery;
a first magnet; and
a generator element including a second magnet, a shaft, and an induction winding;
both the first magnet and the induction winding fixed on the shaft, the induction winding received in the second magnet and electrically connected to the rechargeable battery, and all of the first magnet, the shaft, and the induction winding being rotatable relative to the second magnet;
wherein when an external magnetic force is applied to the first magnet, the first magnet, the shaft, and the induction winding are driven to rotate relative to the second magnet, and the induction winding rotates relative to the second magnet, causing induction current to be generated in the induction winding due to electromagnetic induction between the second magnet and the induction winding and transmitted to the rechargeable battery to charge the rechargeable battery.

12. The portable electronic device of claim 11, wherein the generator element further includes two commutators and two brushes; the two commutators are fixed on the shaft and respectively electrically connected to two ends of the induction winding, and the two brushes are fixed relative to the second magnet and respectively positioned adjacent to outside surfaces of the two commutators; and when the shaft rotates relative to the second magnet, each of the two commutators is driven to alternately contact and electrically connect with each of the two brushes.

13. The portable electronic device of claim 12, wherein the second magnet is a substantially hollow cylinder, the shaft is coaxially received in the second magnet, and the induction winding is coiled on the shaft.

14. The portable electronic device of claim 13, wherein both two ends of the shaft expose out of the second magnet, the two commutators are respectively fixed on two opposite sides of one end of the shaft exposed out of the second magnet, and the first magnet is substantially disk-shaped and coaxially fixed on the other end of the shaft exposed out of the second magnet.

15. The portable electronic device of claim 14, wherein the generator element further includes a securing case; the second magnet, the induction winding, the two commutators, and the two brushes are all received in the securing case, and the second magnet and the two brushes are all fixed to an inner surface of the securing case.

16. The portable electronic device of claim 15, wherein the generator element further includes an electromagnetic shielding cover, the securing case is received in the electromagnetic shielding cover, and the first magnet exposes out of the electromagnetic shielding cover.

17. The portable electronic device of claim 16, wherein the generator element further includes an eccentric wheel; the eccentric wheel is fixed on a side of the shaft and positioned adjacent to the first magnet, and the eccentric wheel exposes out of the shielding cover.

18. The portable electronic device of claim 17, wherein the mobile portion further includes a circuit board and a charging circuit integrated within the circuit board; both the securing case and the electromagnetic shielding cover are fixed on the circuit board, and both the two brushes are electrically connected to the rechargeable battery via the charging circuit.
